(19) United States
(12) Patent Application Publication
(10) Pub. No.: US 2024/0073515 A1
(43) Pub. Date: Feb. 29, 2024

(54) DOCUMENT CAMERA, IMAGE AUTOMATIC CORRECTION METHOD AND NON-TRANSITORY COMPUTER READABLE MEDIUM

(71) Applicant: AVer Information Inc., New Taipei City (TW)

(72) Inventors: You-Chang LIN, New Taipei City (TW); Zong Yuan PAN, New Taipei City (TW)

(21) Appl. No.: 18/455,637

(22) Filed: Aug. 25, 2023

(30) Foreign Application Priority Data
Aug. 25, 2022 (TW) 111132069

(51) Int. Cl. H04N 23/60; G06T 7/00; G06T 7/13; G06T 7/80; H04N 5/262; H04N 23/67

(52) U.S. Cl. CPC H04N 23/64; G06T 7/13; G06T 7/80; G06T 7/97; H04N 5/2628; H04N 23/67; G06T 2207/30168; G06T 2207/30176

(57) ABSTRACT

The present disclosure provides an image automatic correction method of a document camera, and the image automatic correction method includes steps as follows. An image is captured; at least one image feature value is extracted from the image, and whether an imaged picture has changed is determined according to the at least one image feature value of the image and at least one previous image feature value of a previous image; when the imaged picture has changed as determined, a focal length value is calculated, and whether the image needs to be rotated is determined according to the focal length value.

### CROSS-REFERENCE TO RELATED APPLICATION

This application claims priority to Taiwan Application Serial Number 111132069, filed Aug. 25, 2022, which is herein incorporated by reference.

### BACKGROUND

### Field of Invention

The present invention relates to projectors and correction methods, and more particularly, document cameras, image automatic correction methods thereof and non-transitory computer readable mediums.

### Description of Related Art

Traditionally, when using a document camera as a briefing device, the image can be output after shooting an object (e.g., a document or a model on the tabletop) through the lens device, and the operation is simple.

However, when the document camera is used as a video conference camera, due to the change of the shooting angle, the imaged picture has the problem of changing the angle, so the user must manually correct the shooting direction of the lens device or manually operate the image processing software to rotate 180 degrees to achieve the correct orientation of the output of the imaged picture.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

According to embodiments of the present disclosure, the present disclosure provides document cameras and image automatic correction methods thereof, to solve or circumvent aforesaid problems and disadvantages in the related art.

An embodiment of the present disclosure is related to a document camera, and the document camera includes an image sensor, an image transmission device and a processing device. The image transmission device is electrically connected to the image sensor, and the processing device is electrically connected to the image transmission device. The image sensor is configured to capture an image. The processing device is configured to extract at least one image feature value from the image, and to determine whether an imaged picture has changed according to the at least one image feature value of the image and at least one previous image feature value of a previous image. When the imaged picture has changed as determined, the processing device is configured to calculate a focal length value, and to determine whether the image needs to be rotated according to the focal length value.

Another embodiment of the present disclosure is related to an image automatic correction method, and the image automatic correction method includes steps of: capturing an image; extracting at least one image feature value from the image, and determining whether an imaged picture has changed according to the at least one image feature value of the image and at least one previous image feature value of a previous image; when the imaged picture has changed as determined, calculating a focal length value, and determining whether the image needs to be rotated according to the focal length value.

Yet another embodiment of the present disclosure is related to a non-transitory computer readable medium to store a plurality of instructions for commanding a computer to execute an image automatic correction method, and the image automatic correction method includes steps of: capturing an image; extracting at least one image feature value from the image, and determining whether an imaged picture has changed according to the at least one image feature value of the image and at least one previous image feature value of a previous image; when the imaged picture has changed as determined, calculating a focal length value, and determining whether the image needs to be rotated according to the focal length value.

In view of the above, with the document camera and its image automatic correction method of the present disclosure, the image of the document camera can be automatically corrected without additional hardware (e.g., a sensor), thereby eliminating the inconvenience caused by manual correction and greatly improving the user experience.

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the following detailed description of the embodiment, with reference made to the accompanying drawings as follows:

FIG. 1 is a block diagram of a document camera according to some embodiments of the present disclosure; and

FIG. 2 is a flow chart of an image automatic correction method of the document camera according to some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

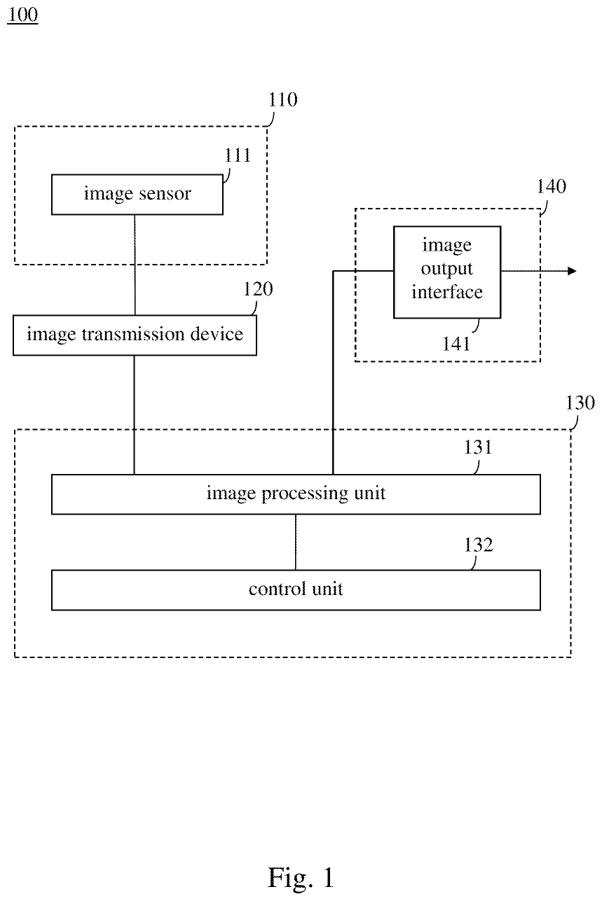

FIG. 1 is a block diagram of a document camera 100 according to some embodiments of the present disclosure. As shown in FIG. 1, the document camera 100 includes a lens device 110, an image transmission device 120, a processing device 130, and an output device 140. In structure, the lens device 110 is electrically connected to the image transmission device 120, the image sensor 111 is disposed in the lens device 110, the image sensor 111 is electrically connected to the image transmission device 120, the image transmission device 120 is electrically connected to the processing device 130, and the processing device 130 is electrically connected to the output device 140.

In use, the lens device 110 acquires images, the image transmission device 120 transmits the images to the processing device 130, and the processing device 130 automatically corrects the images and transmits the imaged pictures corresponding to the images to the output device 140, so that the output device 140 can outputs the imaged pictures.

In practice, for example, the lens device 110 can include an image sensor 111, an optical lens assembly, and a gear member for controlling the aforementioned optical lens assembly. In structure, the image sensor 111 is disposed in the lens device 110, and the image sensor 111 is electrically connected to the image transmission device 120. The image transmission device 120 is an adjustable image transmission device (e.g., a gooseneck bendable image transmission device, a reversible image transmission device, a retractable image transmission device and so on). The processing device 130 can include an image processing unit 131 and a control unit 132. In structure, the image transmission device 120 is electrically connected to the image processing unit 131, and the image processing unit 131 is electrically connected to the control unit 132. The output device 140 can include at least one image output interface 141, where the image output interface 141 can be a universal serial bus (USB), a high definition multimedia interface (HDMI), a video graphics array (VGA) or another image output interface. In some embodiments, the image transmission device 120 can be an image transmission line or a data transmission line.

Regarding the way of automatic image correction, in some embodiments of the present disclosure, the image sensor 111 is configured to capture an image. The processing device 130 is configured to extract at least one image feature value from the image, and to determine whether an imaged picture has changed according to the at least one image feature value of the image and at least one previous image feature value of a previous image. When the imaged picture has changed as determined, the processing device 130 is configured to calculate a focal length value, and to determine whether the image needs to be rotated according to the focal length value.

Regarding the way of determining whether the image has changed, in some embodiments of the present disclosure, the image sensor 111 sequentially captures the previous image and the image, and the processing device 130 extracts a plurality of previous image feature values from the previous image and a plurality of image feature values from the image, and then determines whether a ratio of a number of one or more equal feature values of matching the previous image feature values with the image feature values to a total number of the previous image feature values used for matching the image feature values is less than a preset threshold, and when the ratio is less than the preset threshold, the processing device 130 determines that the imaged picture has changed.

Then, when the imaged picture has changed as determined, the processing device 130 calculates the focal length value and an image blur value of the image, and then determines whether the image needs to be rotated according to the focal length value and the image blur value of the image.

Specifically, when the processing device 130 determines that the imaged picture has changed, the processing device 130 is configured to control the lens device 110 to perform an autofocus, and to perform the edge detection on the image to obtain the image blur value, where the image blur value is positively correlated with definition of the image. The processing device 130 determines whether the image blur value is greater than a predetermined threshold. Whenever the image blur value is not greater than the predetermined threshold, the processing device 130 controls the lens device 110 to perform the autofocus repeatedly until the image blur value is greater than the predetermined threshold. When the image blurring value is greater than the predetermined threshold, the processing device 130 determines that the image is not blurred.

After the image is not blurred, the processing device 130 extracts the focal length value of the lens device 110, and determines whether the imaged picture is a tabletop picture according to the image blur value and the focal length value; for example, the image blur value and the focal length value can be inputted into the machine learning model for determining whether the imaged picture is the tabletop picture. When the imaged picture is not the tabletop picture as determined, the processing device 130 rotates the image. In some embodiments, it is also possible to use the image blur value and the focal length value through a table lookup (e.g., a built-in database or a cloud database) for determining whether the imaged picture is the tabletop picture.

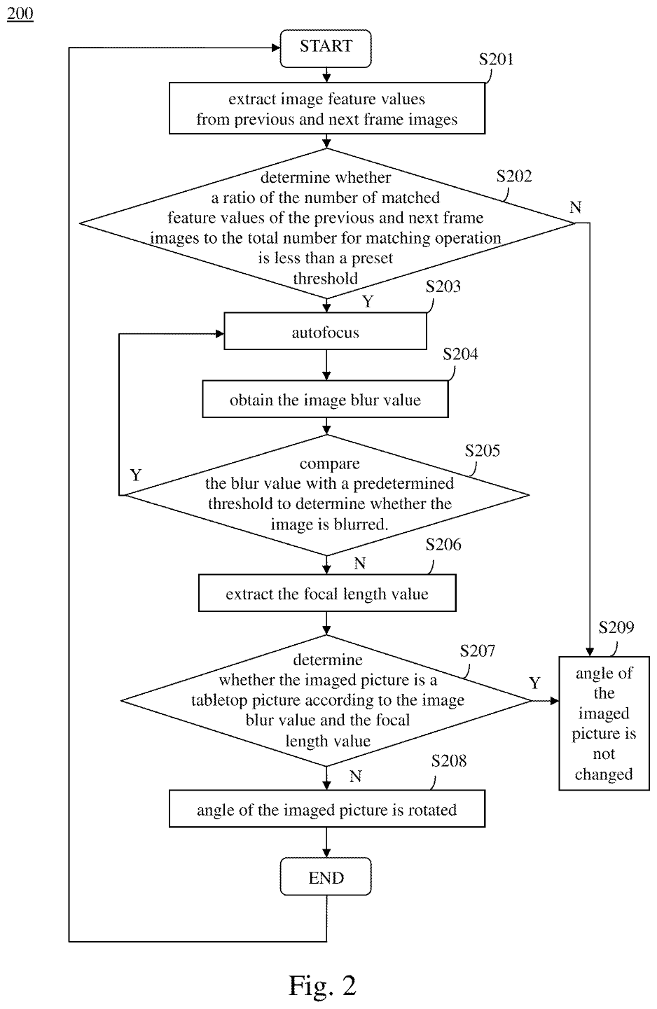

For a more complete understanding of an image automatic correction method of the document camera 100, referring FIG. 1 and FIG. 2, FIG. 2 is a flow chart of the image automatic correction method 200 of the document camera 100 according to an embodiment of the present disclosure. As shown in FIG. 2, the image automatic correction method 200 includes steps S201 to S209. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently.

The image automatic correction method 200 may take the form of a computer program product on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

In the image automatic correction method 200, an image is captured; at least one image feature value is extracted from the image, and whether an imaged picture has changed is determined according to the at least one image feature value of the image and at least one previous image feature value of a previous image; when the imaged picture has changed as determined, a focal length value is calculated, and whether the image needs to be rotated is determined according to the focal length value.

Specifically, in step S201, the previous image (e.g., a previous frame image) and the image (e.g., a next frame image after the previous frame image) are captured sequentially; a plurality of previous image feature values (e.g., image feature values of the previous frame image) are extracted from the previous image, and a plurality of image feature values (e.g., image feature values of the next frame image after the previous frame image) are extracted from the image.

In practice, for example, the ORB (Oriented FAST and Rotated BRIEF) feature extraction algorithm can extract the image feature values of the previous and next frame images. In the image, the pixel color difference between the corner of the object and its surrounding environment is usually large, so this feature is often used as the feature point of the object. The ORB feature extraction algorithm is an algorithm that can quickly extract and describe the feature points, and the extracted features points are generated with binary codes to generate descriptors. The present disclosure uses this algorithm to search for feature points on the previous and next frame images respectively as feature points of different images, obtains the positions of the feature points and the feature descriptors of the previous and next frame images, and uses the Hamming distance for matches the feature descriptors of the previous and next frame images, in which when the features are closer, the distance value is smaller.

In step S202, whether a ratio of a number of one or more equal feature values of matching the previous image feature values (e.g., the image feature values of the previous frame image) with the image feature values (e.g., the image feature values of the next frame image after the previous frame image) to a total number of the previous image feature values used for matching the image feature values is less than a preset threshold is determined.

In practice, for example, the number of feature points successfully matched according to the Hamming distance is averaged with all the feature points searched by ORB. After testing, about 0.05 is used as the preset threshold. When the matching ratio is less than 0.05, the imaged picture has changed, and the next processes are performed in the next step. When the matching ratio is greater than 0.05, the imaged picture is not changed, and the current image is output directly.

Specifically, when the ratio is greater than or equal to the preset threshold, the previous and next frame images are substantially equal or similar to each other. In step S209, it is determined that the imaged picture is not changed, and therefore the angle of the imaged picture corresponding to the image is not changed.

When the ratio is less than the preset threshold, the previous and next frame images are substantially different or not similar. In step S203, it is determined that the image has changed, and the lens device 110 of the document camera 100 is controlled to perform the autofocus.

In step S204, the edge detection is performed on the image to obtain the image blur value, where the image blur value is positively correlated with definition of the image. In practice, for example, the image blurring value can be obtained by using the edge processes (Laplacian) for performing the numerical average. The present disclosure uses the edge image to represent the blurring degree of the image. When the image is more complex and therefore has more edges, the blur value is greater (i.e., clearer). When the image has less edges, the blur value is smaller (i.e., more blurred).

In step S205, the blur value is compared with a predetermined threshold to determine whether the image is blurred. Specifically, in step S205, it is determined whether the image blur value is greater than the predetermined threshold. Whenever the image blur value is not greater than the predetermined threshold, the image is blurred; step S203 is returned to perform the autofocus repeatedly until the image blur value is greater than the predetermined threshold. In other words, when the image blur value is greater than the predetermined threshold, it is determined that the image is not blurred in step S205.

In practice, for example, when it is determined that the image has changed through the previous and next frame image, the autofocus (AF) function of the document camera 100 is enabled, and the latest focal length value of the current image is obtained. The edge detection can be performed on the image through the Laplacian high-pass filter, and the edge is less obvious when the image is more blurred. Through aforesaid features, after filtering the image with the high-pass filter, only the edge of the image remains, and then the entire image is averaged, so as to obtain the image blur value. The present disclosure can also divide the image into multiple areas (e.g., nine grid areas), perform the high-pass filtering on each area, and take the average value as the image blur value of each area.

In step S206, the focal length value of the lens device 110 is extracted. In practice, for example, the focal length value may be a gear focal length value, and the gear focal length value is a rotational position parameter of the gear member, which corresponds to the optical focal length value of the optical lens assembly. In practice, the document camera 100 has a built-in gear focal length value. The gear focal length value can be used for adjusting the optical lens assembly according to the distance of the object, so that the image can be clear. The focal length value can be used for quickly determining whether the document camera 100 looks up or down. Furthermore, in order to improve the determination accuracy, for example, the image blur value can be combined with the built-in focal length value of document camera 100 to make the following overall determination.

In step S207, it is determined whether the imaged picture is a tabletop picture according to the image blur value and the focal length value. In practice, for example, the image blur value and the focal length value can be inputted into a machine learning model to determine whether the imaged picture is a tabletop picture, and the machine learning model can be a classification model based on a support vector machine (SVM) algorithm. In some embodiments, it is also possible to use the image blur value and the focal length value through a table lookup (e.g., a built-in database or a cloud database) for determining whether the imaged picture is the tabletop picture.

The SVM algorithm is a supervised algorithm. For the training samples given, the categories need to be marked in advance. It can classify high-dimensional feature data. The kernel function used in the present disclosure is RBF (Radial Basis Function), which can map the original features to a high-dimensional space for nonlinear classification.

Before the automated processes, a large number of the above-mentioned obtained data (e.g., the built-in gear focal length value of document camera 100, the image and/or the image blurring value of each area) are collected and these features are marked (e.g., tabletop and non-tabletop), After marking, the SVM algorithm is used for training. The SVM calculates the classification hyperplane (i.e., the classification model) based on the above feature vectors, and the data can be classified and divided through this classification model.

At the end of the automated processes, the currently acquired features (e.g., the built-in gear focal length value of the document camera 100, the image and/or the image blurring value of each area) can be input into the SVM classification model, and the SVM classification model can be based on the previously trained hyperplane for classification and division. When this feature is classified as the non-tabletop, the image is rotated 180 degrees to output the rotated image. When this feature is classified as the tabletop, the original image is continued to be output. The SVM classification model can have a good classification ability for unknown data, and can use different kernel functions to map data to high-dimensional space for processes.

Alternatively, in practice, for example, the machine learning model in step S207 can be a classification model based on logistic regression, which is a logarithmic probability model that mainly finds a line that can distinguish two types of data. The logistic regression classification model is highly interpretable, predicts a probability between 0 and 1, and is suitable for continuous features.

Alternatively, in practice, for example, the machine learning model in step S207 can be a classification model based on the KNN algorithm, which measures the similarity between samples by distance, and the samples are divided into k groups. The KNN classification model is suitable for multi-classification problems and can be used for nonlinear classification.

Alternatively, in practice, for example, the machine learning model in step S207 can be a classification model based on a decision tree to solve linear inseparable problems and is suitable for discrete data. The decision tree classification model can processes irrelevant features, and the calculation is simple, fast, and interpretable.

In FIG. 2, when step S207 determines that the imaged picture is not a tabletop picture, in step S208, the image is rotated, so that the imaged picture corresponding to the image is rotated (e.g., 180 degrees), so as to automatically correct the document camera 100, and therefore the document camera 100 can serve as a video conference camera.

Conversely, when step S207 determines that the imaged picture is a tabletop picture, the angle of the imaged picture corresponding to the image remains unchanged in step S209. At this time, document camera 100 is still used as a briefing device.

In view of the above, with the document camera 100 and its image automatic correction method 200 of the present disclosure, the image of the document camera 100 can be automatically corrected without additional hardware (e.g., a sensor), thereby eliminating the inconvenience caused by manual correction and greatly improving the user experience.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A document camera, comprising:
an image sensor configured to capture an image;
an image transmission device electrically connected to the image sensor; and
a processing device electrically connected to the image transmission device, the processing device configured to extract at least one image feature value from the image, and to determine whether an imaged picture has changed according to the at least one image feature value of the image and at least one previous image feature value of a previous image, and when the imaged picture has changed as determined, the processing device configured to calculate a focal length value, and to determine whether the image needs to be rotated according to the focal length value.

2. The document camera of claim 1, wherein when the imaged picture has changed as determined, the processing device calculates the focal length value and an image blur value of the image, and then determines whether the image needs to be rotated according to the focal length value and the image blur value of the image.

3. The document camera of claim 2, further comprising:
a lens device electrically connected to the image transmission device, the image sensor disposed in the lens device, when the processing device determines that the imaged picture has changed, the processing device configured to control the lens device to perform an autofocus, and to perform an edge detection on the image to obtain the image blur value, wherein the image blur value is positively correlated with definition of the image, the processing device determines whether the image blur value is greater than a predetermined threshold, and whenever the image blur value is not greater than the predetermined threshold, the processing device controls the lens device to perform the autofocus repeatedly until the image blur value is greater than the predetermined threshold, and when the image blurring value is greater than the predetermined threshold, the processing device determines that the image is not blurred.

4. The document camera of claim 3, wherein after the image is not blurred, the processing device extracts the focal length value of the lens device, and determines whether the imaged picture is a tabletop picture according to the image blur value and the focal length value, and when the imaged picture is not a tabletop picture as determined, the processing device rotates the image.

5. The document camera of claim 1, wherein the image sensor sequentially captures the previous image and the image, and the processing device extracts a plurality of previous image feature values from the previous image and a plurality of image feature values from the image, and then determines whether a ratio of a number of one or more equal feature values of matching the previous image feature values with the image feature values to a total number of the previous image feature values used for matching the image feature values is less than a preset threshold, and when the ratio is less than the preset threshold, the processing device determines that the imaged picture has changed.

6. An image automatic correction method of a document camera, comprising steps of:
capturing an image;
extracting at least one image feature value from the image, and determining whether an imaged picture has changed according to the at least one image feature value of the image and at least one previous image feature value of a previous image; and
when the imaged picture has changed as determined, calculating a focal length value, and determining whether the image needs to be rotated according to the focal length value.

7. The image automatic correction method of claim 6, wherein the step of when the imaged picture has changed as determined, calculating the focal length value, and determining whether the image needs to be rotated according to the focal length value comprises:
when the imaged picture has changed as determined, calculating the focal length value and an image blur value of the image, and then determining whether the image needs to be rotated according to the focal length value and the image blur value of the image.

8. The image automatic correction method of claim 7, further comprising:
when the imaged picture has changed as determined, controlling a lens device of the document camera to perform an autofocus, and performing an edge detection on the image to obtain the image blur value, wherein the image blur value is positively correlated with definition of the image;
determining whether the image blur value is greater than a predetermined threshold, and whenever the image blur value is not greater than the predetermined threshold, controlling the lens device to perform the autofocus repeatedly until the image blur value is greater than the predetermined threshold; and
when the image blurring value is greater than the predetermined threshold, determining that the image is not blurred.

9. The image automatic correction method of claim 8, wherein the step of determining whether the image needs to be rotated according to the focal length value and the image blur value of the image comprises:
after the image is not blurred, extracting the focal length value of the lens device, and determining whether the imaged picture is a tabletop picture according to the image blur value and the focal length value; and
when the imaged picture is not a tabletop picture as determined, rotating the image.

10. The image automatic correction method of claim 6, wherein the step of determining whether the imaged picture has changed according to the at least one image feature value of the image and at least one previous image feature value of the previous image comprises:
extracting a plurality of previous image feature values from the previous image and a plurality of image feature values from the image;
determining whether a ratio of a number of one or more equal feature values of matching the previous image feature values with the image feature values to a total number of the previous image feature values used for matching the image feature values is less than a preset threshold; and
when the ratio is less than the preset threshold, determining that the imaged picture has changed.

11. A non-transitory computer readable medium to store a plurality of instructions for commanding a computer to execute an image automatic correction method, and the image automatic correction method comprising steps of:
capturing an image;
extracting at least one image feature value from the image, and determining whether an imaged picture has changed according to the at least one image feature value of the image and at least one previous image feature value of a previous image; and
when the imaged picture has changed as determined, calculating a focal length value, and determining whether the image needs to be rotated according to the focal length value.

12. The non-transitory computer readable medium of claim 11, wherein the step of when the imaged picture has changed as determined, calculating the focal length value, and determining whether the image needs to be rotated according to the focal length value comprises:
when the imaged picture has changed as determined, calculating the focal length value and an image blur value of the image, and then determining whether the image needs to be rotated according to the focal length value and the image blur value of the image.

13. The non-transitory computer readable medium of claim 12, wherein the image automatic correction method further comprises:
when the imaged picture has changed as determined, controlling a lens device of a document camera to perform an autofocus, and performing an edge detection on the image to obtain the image blur value, wherein the image blur value is positively correlated with definition of the image;
determining whether the image blur value is greater than a predetermined threshold, and whenever the image blur value is not greater than the predetermined threshold, controlling the lens device to perform the autofocus repeatedly until the image blur value is greater than the predetermined threshold; and
when the image blurring value is greater than the predetermined threshold, determining that the image is not blurred.

14. The non-transitory computer readable medium of claim 13, wherein the step of determining whether the image needs to be rotated according to the focal length value and the image blur value of the image comprises:
after the image is not blurred, extracting the focal length value of the lens device, and determining whether the imaged picture is a tabletop picture according to the image blur value and the focal length value; and
when the imaged picture is not a tabletop picture as determined, rotating the image.

15. The non-transitory computer readable medium of claim 11, wherein the step of determining whether the imaged picture has changed according to the at least one image feature value of the image and at least one previous image feature value of the previous image comprises:
extracting a plurality of previous image feature values from the previous image and a plurality of image feature values from the image;
determining whether a ratio of a number of one or more equal feature values of matching the previous image feature values with the image feature values to a total number of the previous image feature values used for matching the image feature values is less than a preset threshold; and
when the ratio is less than the preset threshold, determining that the imaged picture has changed.
